(19) United States
(12) Patent Application Publication
(10) Pub. No.: US 2006/0238524 A1
(43) Pub. Date: Oct. 26, 2006

(54) SIGNAL CONVERSION APPARATUS FOR DISPLAY DEVICE

(76) Inventors: Kuan-Hong Hsieh, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,276

(22) Filed: Nov. 16, 2005

(30) Foreign Application Priority Data
Apr. 22, 2005 (CN) 200510034352.X

(51) Int. Cl. G09G 5/00

(52) U.S. Cl. 345/204

(57) ABSTRACT

A signal conversion apparatus, connected to one or more electronic apparatuses and a display device, mainly includes one or more input interfaces, a signal conversion unit, and an output interface. Each input interface is for connecting to an electronic apparatus and receiving signals therefrom. The input interfaces include analog interfaces and digital interfaces. The signal conversion unit is for receiving the signals in multiple formats from the input interfaces, and converting the signals, when necessary, into a predetermined format, which is supported by the display device. The predetermined format includes RF format, RCA format, S-Video format, YPbPr/YCbCr format, VGA format, MPEG format, DVI format, HDMI format, and so on. The output interface is for transmitting the signals from the signal conversion unit to the display device through a cable. The display device receives the signals from the output interface and displays corresponding information thereof.

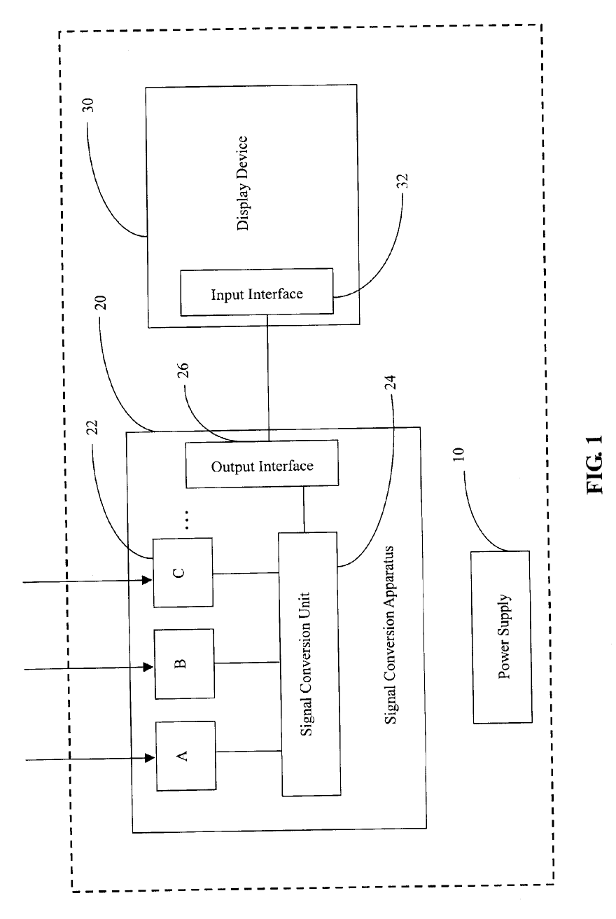

### FIELD OF THE INVENTION

The present invention relates to signal conversion apparatuses, and particularly to a signal conversion apparatus used in an electronic apparatus such as a display device.

### DESCRIPTION OF RELATED ART

Recently, the electronic display device market has experienced exponential growth, along with a corresponding growth in the market for multimedia devices. Such devices include, for example, digital photo browsers, MPEG players, MP3 players, VCD/DVD players, digital still cameras (DSCs), camcorders, multimedia viewers (MMVs), photo storage viewers (PSVs), and so on. These multimedia devices allow the user to view digital photos, MPEG videos, VCD/DVD programs, and listen to MP3 audio, as well as produce and permanently store digital photos, video programs, and audio programs, all through the display devices connected thereto.

However, each of the abovementioned multimedia devices is typically only capable of providing signals in a particular format to the display devices. Such signals may be VGA (Video Graphics Array) signals, S-Video signals, composite video signals, and so forth. Consequently, the display devices need to be capable of supporting a variety of formatted signals. That is, the display devices have to provide various interfaces for respectively receiving the variously formatted signals.

With the increasing number of multimedia devices, the number of interfaces on display devices is increasing correspondingly. Additionally, these interfaces generally are positioned at the back of the display device. Accordingly, it is inconvenient for the user to connect the display device with the multimedia devices when the user is in front of the display device. Furthermore, there are a plurality of cables connected between the display device and the multimedia devices. Consequently, these cables are liable to become tangled and be aesthetically impact when they are in disorder.

In addition, if a display device is capable of only supporting a few designated signal formats, this limits the choices of the user to only those multimedia devices using one of these signal formats.

What is needed, therefore, is a signal conversion apparatus which connects one or more multimedia devices to a display device, and which converts variously formatted signals into a predetermined signal format corresponding to a format supported by the display device.

### SUMMARY OF INVENTION

A signal conversion apparatus, which connects one or more electronic apparatuses to a display device, is provided. The signal conversion apparatus mainly includes one or more input interfaces, a signal conversion unit, and an output interface. Each input interface is for connecting to an electronic apparatus and receiving signals from the electronic apparatus, the signals being in a format designated by that electronic apparatus. The input interfaces include analog interfaces and digital interfaces. The analog interfaces may include an RF (Radio Frequency) interface, an RCA (Phono Connector) interface, an S-Video (Separate Video) interface, a YPbPr/YCbCr interface, a VGA (Video Graphics Array) interface, and the like. The digital interfaces may include a USB (Universal Serial Bus) interface, an IEEE1394 interface, a DVI (Digital Video Interface), an HDMI (High Definition Multimedia Interface), and so forth. The signal conversion unit is for receiving the signals from the input interfaces, and converting the signals, when necessary, into a predetermined format supported by the display device. The predetermined format includes RF format, RCA format, S-Video format, YPbPr/YCbCr format, VGA format, MPEG format, DVI format, HDMI format, and so on. The output interface is for transmitting the signals from the signal conversion unit to the display device through a cable. The display device receives the signals from the output interface and displays corresponding information thereof.

Other advantages and novel features will be drawn from the following detailed description with reference to the attached drawing, in which:

### BRIEF DESCRIPTION OF DRAWINGS

The drawing is a block diagram of an exemplary display system in accordance with a preferred embodiment of the present invention.

### DETAILED DESCRIPTION

The drawing is an illustration of an exemplary display system in accordance with a preferred embodiment of the present invention. The display system includes a power supply 10, a signal conversion apparatus 20, and a display device 30. The signal conversion apparatus 20 is capable of: (i) receiving signals in multiple formats from electronic apparatuses (not shown); (ii) converting these signals, when necessary, into a predetermined format supported by the display device 30; and (iii) then transmitting the converted signals to the display device 30. The display device 30 displays information for a user according to the converted signals. The power supply 10 provides power to the signal conversion apparatus 20, the electronic apparatus connected thereto, and the display device 30. In this embodiment, the power supply 10 is separate from the signal conversion apparatus 20. However, in other embodiments, the power supply 10 can be included in the signal conversion apparatus 20.

The signal conversion apparatus 20 mainly includes a plurality of input interfaces 22 (symbolically expressed as A, B, C, and so on), a signal conversion unit 24, and an output interface 26. Each of the input interfaces 22 is for connecting a respective electronic apparatus and receiving corresponding signals in a particular format therefrom.

The electronic apparatus may be any type of multimedia device, such as a digital photo browser, an MPEG player, an MP3 player, a VCD/DVD player, a digital still camera (DSC), a camcorder, an MMV (multimedia viewer), or a PSV (photo storage viewer), as should be apparent to persons skilled in the relevant art(s). Correspondingly, the input interfaces 22 may be either analog interfaces or digital interfaces. The analog interfaces include an RF interface, an RCA interface, an S-Video interface, a YPbPr/YCbCr interface, a VGA interface, as well as other well known analog interfaces known to persons skilled in the relevant art(s). The digital interfaces include a USB interface, an IEEE1394 interface, a DVI, an HDMI, as well as other well known digital interfaces known to persons skilled in the relevant art(s). Consequently, the formats of the signals from the input interfaces 22 may be RF format, RCA format, S-Video format, YPbPr/YCbCr format, VGA format, MPEG format, DVI format, HDMI format, and the like.

The signal conversion unit 24 receives the signals from the input interfaces 22, and converts the signals when necessary. That is, when the display device 30 is capable of receiving the signal in the existing format, the signal conversion unit 24 directly transmits the signals to the display device 30 without conversion. Alternatively, when the display device 30 is capable of receiving signals in one or more but not all of different formats, the signal conversion unit 24 converts those signals of unsupported format into signals of a predetermined format which is supported by the display device 30. The output interface 26 transmits the signals from the signal conversion unit 24 to the display device 30 through a cable.

The display device 30 is typically a graphical display, such as a flat panel display or a cathode ray tube (CRT) display. The display device 30 includes an input interface 32, which is either an analog interface, a digital interface, or a combination thereof. Similar to the input interface 22, the analog interface may be an RF interface, an RCA interface, an S-Video interface, a YPbPr/YCbCr interface, or a VGA interface, as well as other well known analog interfaces known to persons skilled in the relevant art(s). The digital interface may be a USB interface, an IEEE1394 interface, a DVI, or an HDMI, as well as other well known digital interfaces known to persons skilled in the relevant art(s). Accordingly, the signal formats which the display device 30 can support are dependent on the input interface 32 of the display device 30. The signal conversion unit 24 transforms the output signal to the signal format which corresponds to the input interface 32. For example, when the input interface 32 is an S-Video interface, and the signal conversion unit 24 receives signals in a different format from the input interface 22, the signal conversion unit 24 converts the signals into the S-Video format which is supported by the display device 30, and then transmits the converted signals to the input interface 32 through the output interface 26. Upon receiving signals from the output interface 26, the display device 30 converts the received signals into text and/or one or more graphical images for display to a user.

Accordingly, with the aid of the signal conversion apparatus 20, the display device 30 can connect to a plurality of peripheral electronic apparatuses including those having formats which the display device 30 itself does not support. Thereby, the range of compatibility of the display device 30 is extended. Furthermore, the display device 30 requires only a single cable to connect with the various peripheral electronic apparatuses via the signal conversion apparatus 20. This avoids the disorder of a plurality of cables being connected between the display device and the peripheral electronic apparatuses.

Although the present invention has been specifically described on the basis of preferred embodiments thereof, the invention is not to be construed as being limited thereto. Various changes or modifications may be made to the embodiments without departing from the scope and spirit of the invention.

What is claimed is:

1. A signal conversion apparatus for connecting to a power supply and a display device, the signal conversion apparatus comprising:
one or more input interfaces for connecting to an electronic apparatus and receiving signals therefrom, the signals being in a designated format;
an output interface, for connecting with the display device; and
a signal conversion unit, for converting when necessary the signals in the designated format into a predetermined format which is supported by the display device, and outputting the converted signals to the display device through the output interface.

2. The signal conversion apparatus according to claim 1, further comprising a power supply for providing power to the signal conversion apparatus, the electronic apparatuses connected thereto, and the display device.

3. The signal conversion apparatus according to claim 2, wherein the input interfaces comprise one or more analog interfaces and/or one or more digital interfaces.

4. The signal conversion apparatus according to claim 3, wherein the analog interfaces are selected from the group consisting of an RF (Radio Frequency) interface, an RCA (Phono Connector) interface, an S-Video (Separate Video) interface, a YPbPr/YCbCr interface, and a VGA (Video Graphics Array) interface; and the digital interfaces are selected from the group consisting of a USB (Universal Serial Bus) interface, an IEEE1394 interface, a DVI (Digital Video Interface), and an HDMI (High Definition Multimedia Interface).

5. The signal conversion apparatus according to claim 4, wherein the predetermined format is selected from the group consisting of RF format, RCA format, S-Video format, YPbPr/YCbCr format, VGA format, MPEG format, DVI format, and HDMI format.

6. The signal conversion apparatus according to claim 5, wherein the output interface is connected with the display device through a cable.

7. A signal conversion apparatus for connecting to a display device, the signal conversion apparatus comprising:
one or more input interfaces, each of which is for connecting to an electronic apparatus and receiving signals therefrom, the signals being in a designated format;
an output interface, for connecting with the display device;
a signal conversion unit, for converting when necessary the signals in the designated format into a predetermined format which is supported by the display device, and outputting the converted signals to the display device through the output interface; and
a power supply, for providing power to the signal conversion apparatus, the display device, and the electronic apparatuses connected thereto.

8. The signal conversion apparatus according to claim 7, wherein the input interfaces comprise one or more analog interfaces and/or one or more digital interfaces.

9. The signal conversion apparatus according to claim 8, wherein the analog interfaces are selected from the group consisting of an RF (Radio Frequency) interface, an RCA (Phono Connector) interface, an S-Video (Separate Video) interface, a YPbPr/YCbCr interface, and a VGA (Video Graphics Array) interface; and the digital interfaces are selected from the group consisting of a USB (Universal Serial Bus) interface, an IEEE1394 interface, a DVI (Digital Video Interface), and an HDMI (High Definition Multimedia Interface).

10. The signal conversion apparatus according to claim 9, wherein the predetermined format is selected from the group consisting of RF format, RCA format, S-Video format, YPbPr/YCbCr format, VGA format, MPEG format, DVI format, and HDMI format.

11. The apparatus according to claim 10, wherein the output interface is connected with the display device through a cable.

12. A display system comprising:
a signal conversion apparatus comprising:
one or more input interfaces, each of which is for connecting to an electronic apparatus and receiving signals therefrom, the signals being in a designated format;
a signal conversion unit, for converting when necessary the signals in the designated format into a predetermined format; and
an output interface, for outputting the converted signals in the predetermined format; and
a display device, for receiving the converted signals from the output interface and displaying corresponding information thereof.

13. The display system according to claim 12, further comprising a power supply for providing power to the signal conversion apparatus, the electronic apparatuses connected thereto, and the display device.

14. The display system according to claim 13, wherein the output interface is connected with the display device through a cable.

15. The display system according to claim 14, wherein the input interfaces comprise one or more analog interfaces and/or one or more digital interfaces.

16. The display system according to claim 15, wherein the analog interfaces are selected from the group consisting of an RF (Radio Frequency) interface, an RCA (Phono Connector) interface, an S-Video (Separate Video) interface, a YPbPr/YCbCr interface, and a VGA (Video Graphics Array) interface; and the digital interfaces are selected from the group consisting of a USB (Universal Serial Bus) interface, an IEEE1394 interface, a DVI (Digital Video Interface), and an HDMI (High Definition Multimedia Interface).

17. The display system according to claim 16, wherein the predetermined format is selected from the group consisting of RF format, RCA format, S-Video format, YPbPr/YCbCr format, VGA format, MPEG format, DVI format, and HDMI format.
